(19) United States
(12) Patent Application Publication
(10) Pub. No.: US 2006/0087973 A1
(43) Pub. Date: Apr. 27, 2006

(54) Delay timers for managing internal state changes and messages in user equipment for real-time multimedia applications

(76) Inventor: Henry Huang, Los Altos, CA (US)

Correspondence Address: IPSG, P.C., P.O. BOX 700640, SAN JOSE, CA, 95170-0640, US

(21) Appl. No.: 11/021,987

(22) Filed: Dec. 24, 2004

Related U.S. Application Data
(60) Provisional application No. 60/621,108, filed on Oct. 22, 2004.

(51) Int. Cl. H04Q 7/20

(52) U.S. Cl. 370/234

(57) ABSTRACT

Timers in push-to-talk (PTT) enabled client devices are used to regulate packet traffic to and from the client device. In one embodiment, timers are used to maximize the user experience that occurs when the presence service is enabled in the PoC System. A first timer controls the flow of presence requests coming uplink from the UE to the presence server, and a second timer controls the flow of presence messages coming downlink from the presence server to the UE and associated presentation on the Man-Machine-Interface (MMI).

### RELATED APPLICATIONS

This application claims priority to U.S. Provisional Application No. 60/621,108, filed on Oct. 22, 2004.

### FIELD

The present invention relates in general to cellular communication technologies and in particular to a method of regulating internal state changes and message sending in user equipment under poor network conditions.

### BACKGROUND

Mobile cellular communication is evolving beyond traditional voice telephony towards more sophisticated services, such as Push-To-Talk (PTT). Similar to conventional walkie-talkie communication, PTT enables mobile communication users to send a voice message to one or more recipients over a mobile phone by simply pushing a key (i.e., PTT button, etc.).

One particular version of PTT, called PoC (PTT-over-Cellular), has started to be implemented in wireless data networks such as GSM/GPRS and CDMA cellular networks. By using internet protocols (i.e., an internet protocol network), these networks can provide a packet-based data service that enables information to be sent and received across a mobile telephone network. In addition, the use of internet protocols also facilitates PoC through the use of instant connections. That is, information can be sent or received immediately as the need arises, subject to available time slots at the air interface.

When the user travels between cells on the data network, there can be significant service degradation. This often occurs when a user moves from an area of high coverage to an area of low coverage. If the user is in a PTT session when this transition happens, the user can experience dropped talk bursts or a terminated call session as the data connection has been terminated due to poor coverage.

Another service problem in PoC systems is due to the use of presence service. When the presence service is enabled, a presence server sends the presence information of contacts in a user's Contact List to the PoC client on the user equipment (UE) to indicate which contacts are online and available for PTT communication.

In order to get this presence information, the PoC client sends a “SUBSCRIBE” message to the presence server to ask for the information. In responding to this message, the presence server may send the contact information in multiple data packets. If the Man Machine Interface (MMI) of the UE is updated in real-time as the packets come in, there can be too many messages in the message queue waiting to be processed. If the user is in a PTT session while these packets are being sent, choppy speech or lost talk bursts can result.

PoC is discussed in greater detail in the following technical specifications which are incorporated by reference: Push-to-talk over Cellular (PoC), Architecture, PoC Release 2.0, V2.0.8 (2004-06); Push-to-talk over Cellular (PoC), Signaling Flows—UE to Network Interface (UNI), PoC Release 2.0, V2.0.6 (2004-06); and Push-to-talk over Cellular (PoC) User Plane, Transport Protocols, PoC Release 2.0, V2.0.8 (2004-06). Of note, Release 1.0 is also available from the PoC Consortium as well as an upcoming PoC standard from Open Mobile Alliance (OMA). All of these are generally considered native PoC standards. Subsequently, a UE (user equipment), such as a PoC enabled cellular phone, supporting either of these standards is called a native PoC client. Additional information is found in IETF RFC 3261, which is incorporated herein by reference. This document describes Session Initiation Protocol (SIP), which is an application-layer control (signaling) protocol for creating, modifying, and terminating sessions with one or more participants. These sessions include Internet telephone calls, multimedia distribution, and multimedia conferences.

### SUMMARY

The present invention advantageously provides on a wireless network, such as a cellular network, delay timers for regulating PTT talk sessions or any other real-time multimedia session using SIP.

In an exemplary embodiment of the invention, a Suspend Timer regulates the session during data communication channel termination. After data communication channel termination, the Suspend Timer is activated. The session is held until Suspend Timer times out. If the data communication channel is restored before the Suspend Timer times out, the session is not reset, and the user is still able to continue the session with little noticeable loss of service. If the Suspend Timer times out, and the data communication channel has not been restored, then the session is terminated.

In another exemplary embodiment, delay timers are used to maximize the user experience that occurs when the presence service is enabled in a real-time multimedia system. A first delay timer controls the flow of presence requests coming uplink from the UE to the presence server, and a second delay timer controls the flow of presence messages coming downlink from the presence server to the UE.

### DESCRIPTION OF THE DRAWINGS

The foregoing and other features, aspects, and advantages will become more apparent from the following detailed description when read in conjunction with the following drawings, wherein:

FIG. 1 is a combination block diagram and flow chart illustrating messages sent between the UE and the PoC System.

FIG. 2 is a combination block diagram and flow chart illustrating the components of the UE of the preferred embodiment and messages sent within the UE and between the UE and the PoC System.

FIG. 3 is a flow chart illustrating the process by which the Suspend Timer is activated and the actions the system takes when this occurs.

FIG. 4 is a timing diagram showing the relationship between the two presence timers and the point at which cached message are sent within the duration of the uplink presence timer.

FIG. 5 is a flow chart illustrating the process by which uplink presence timer is activated and the actions taken by the system in response to uplink presence timer.

FIG. 6 is a flow chart illustrating the process by which downlink presence timer is activated and what actions the system takes when this occurs.

FIG. 7 is a flow chart illustrating the actions of the system when downlink presence timer expires and uplink presence timer is still active.

### DETAILED DESCRIPTION

The invention is described with reference to specific architectures and protocols. Those skilled in the art will recognize that the description is for illustration and to provide the best mode of practicing the invention. The description is not meant to be limiting. For example, reference is made to PoC applications, while other types of real-time multimedia applications can be used in the invention.

A. Architecture

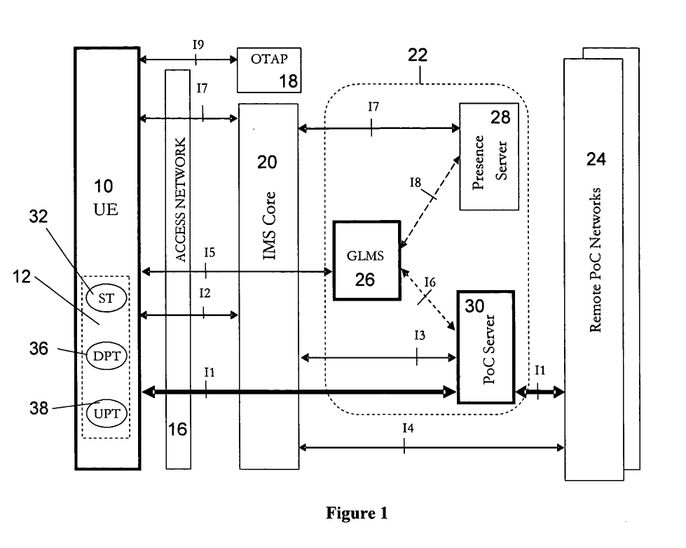

FIG. 1 is a simplified diagram of the PoC architecture, showing the different points where messages travel to and from the user equipment (UE) 10, e.g., a cellular handset or other client device the timers 12 of the preferred embodiment, and the elements of PoC System 14. The timers 12 regulate packet traffic between UE 10 and the PoC System 14. In general, access in the PoC architecture may include both the radio access as well as other IP-enabled transport mechanisms (e.g. a PTT application client is hosted on an Internet-enabled PC). UE 10 generally refers to the device containing the PTT application client software, such as a cellular phone. Within the PoC Architecture, UE 10 uses SIP to establish, modify and terminate multimedia sessions or calls with other PoC enabled clients. A session is considered an exchange of data between associations of participants.

Within the PoC Architecture are UE 10, access network 16, Over the Air Provisioning Server (OTAP) 18, IMS Core 20, PoC Services 22, and remote PoC networks 24. Access network 16 is the communications network for connecting UE 10 to the PoC System 14. In the case of a PoC System 14 (i.e., PTT-over-cellular), access network 16 is a cellular network. The OTAP Server 18 performs the following functions that are needed in support of the PoC Service: provides all the needed configuration parameters from the service provider network for a PoC Client (i.e., UE 10), and sends a WAP-push/SMS containing a binary coded XML to every client UE 10 with default factory and network settings.

The PoC services 22 include Group List Management Server (GLMS) 26, Presence Server 28, and PoC Server 30. As would be obvious to those of ordinary skill in the art, the PoC services 22 may be implemented in a single physical server, in multiple physical servers for each function, or any combination thereof.

Table 1, below, defines the message types associated with the nine interfaces (I1-I9) in FIG. 1.

TABLE 1
File Types Sent in PoC System

| No. | Interface | Message Type |
|---|---|---|
| I1 | Floor Control | RTP Media and RTCP Floor |
| | and media | control and QoS |
| I2 | PoC Client to Proxies | SIP Register, Re-register, |
| | Session Signaling | Invite, Update, Subscribe, |
| | | Notify, Bye, Cancel, Message, |
| | | Publish, Responses (e.g., 200OK.) |
| I3 | Proxy to PoC Server | SIP Invite, Update, Subscribe, |
| | Session Signaling | Notify, Bye, Cancel, Message, |
| | | Responses (e.g., 200OK) |
| I4 | Proxy to Proxy | SIP Invite, Update, Subscribe, |
| | Session Signaling | Notify, Bye, Cancel, Message, |
| | | Presence Publish, Presence |
| | | Subscribe, Presence Notify, |
| | | Responses (e.g., 200OK) |
| I5 | Group Mgmt to | HTTP GET, PUT, SIP XCAP |
| | PoC Client | Subscribe, XCAP Notify |
| I6 | Group Mgmt to | HTTP GET, PUT, SIP XCAP |
| | PoC Server | Subscribe, XCAP Notify |
| I7 | Presence Status | SIP Publish, Subscribe, Notify |
| I8 | Contact Lists | HTTP GET, PUT, SIP XCAP |
| | | Subscribe, XCAP Notify |
| I9 | PoC Client | HTTP/syncXML of device |
| | configuration data | bootstrap/configuration data |

The message types listed above are sent at various times to and from the PoC server 30 and the UE 10 in response to user action on UE 10.

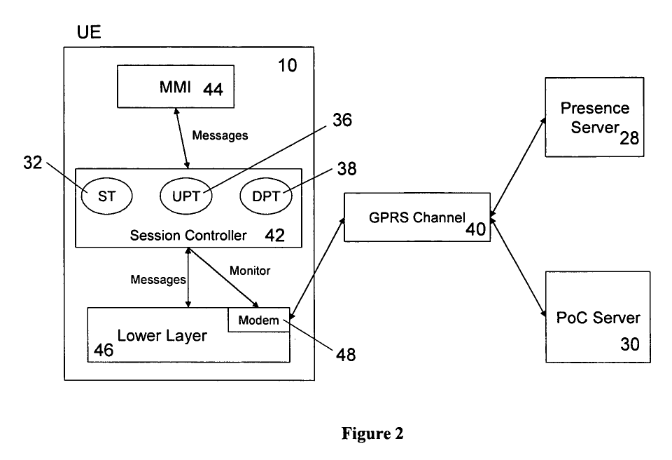

The components of UE 10, which communicate with Presence Server 38 and PoC Server 30 via data communication channel 40 (e.g., a GPRS channel in the event access network 16 uses GPRS for data communications), are depicted in FIG. 2. These components include Session Controller 42, MMI Layer 44, Lower Layer 46 and Modem 48. Within Session Controller 42 are one or more delay timers 12 for regulating real-time multimedia traffic in PoC System 14 under poor access network 16 conditions.

In one embodiment of the invention, a Suspend Timer 32, one of timers 12, located within UE 10 regulates the PTT talk session during data communication suspension. After data communication suspension, the Suspend Timer 32 is activated. The PTT talk session is held until Suspend Timer 32 times out. If data communication channel 40 is restored before the Suspend Timer 32 times out, the PTT session will not be reset, and the user is still able to continue the session with little noticeable loss of service. If the Suspend Timer 32 times out, and data communication channel 40 has not been restored, then the call session will be terminated. This Suspend Timer 32 improves the user experience in the following application areas: low radio coverage area, CS call during the PTT talk session, routing area update, and cell hand over.

In another embodiment, Presence Timers 34, two of timers 12 within UE 10, are used to maximize the user experience that occurs when the presence service (under control of Presence Server 28) is enabled in the PoC System 14. The Presence Timers 34 can alleviate the problem created by the Presence Server 28 sending packets while the user is in a PTT session. The first timer, Uplink Presence Timer 36, controls the flow of presence requests coming uplink from the UE 10 to the Presence Server 28, and the second timer, Downlink Presence Timer 38, controls the flow of presence messages coming downlink from the Presence Server 28 to the UE 10.

Suspend Timer 32 and Presence Timers 34 are preferably implemented as software embedded within the chipset of UE 10. However, Suspend Timer 32 and Presence Timers 34 may be implemented in other hardware and/or software configurations.

B. Suspend Timer

FIG. 2 depicts the relationship between Suspend Timer 32 and data communication channel 40. The Suspend Timer exists in Session Controller 42. Session Controller 42 monitors Modem 48 within Lower Layer 46 of UE 10 in order to ensure that a data communication channel 40 is available for communication with the PoC Server. In case data communication channel 40 is terminated, this will be discovered by Session Controller 42 through the monitoring of the modem. Session Controller 42 then starts the Suspend Timer.

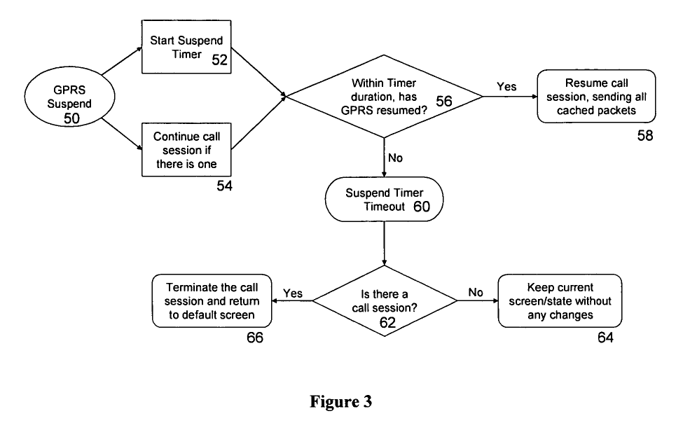

FIG. 3 depicts the process flow of the Suspend Timer 32. When the PTT application starts, data communication channel 40 connection is created. At any time during use, data communication channel 40 may be terminated (Step 50) due to many reasons (low signal strength, cell handover, etc.). When data communication channel 40 is terminated, no application data can be sent or received. While the data communication termination happens, there could be a talk session going on. In this embodiment, if there is a talk session when data communication termination happens, the Suspend Timer is activated (Step 52) and the talk session is continued (Step 54) until the Suspend Timer times out. During the duration of Suspend Timer 32, Session Controller 42 monitors data communication channel 40 via the modem to determine if data communication channel 40 has resumed (Step 56). If data communication channel 40 resumes within the timer period, the talk session shall be continued (Step 58). If the timer times out before data communication channel 40 resumes, the talk session shall be terminated (Step 60).

As long as Suspend Timer 32 is running, the data packets for the PTT session will be cached. If data communication channel 40 resumes before Suspend Timer 32 times out, those cached packets will be sent (Step 58). If the timer times out and the connection is still unavailable (Step 60), then the cached packets are dumped and the PTT call session is terminated (Step 60). The screen presented to the user on UE 10 in this scenario depends upon whether there is a PTT call session. After Suspend Timer 32 times out, Session Controller 42 determines whether there is a call session (Step 62). If there is not a call session, UE 10 keys the current screen star without any changes (Step 64). If there is a call session, Session Controller 42 terminates the call session and UE 10 is returned to the default screen.

C. Presence Timer

FIG. 2 depicts the relationship between Presence Timers 34, Presence Server 28, MMI Layer 40, and Session Controller 42. Presence Timers 34 are examples of delay timers 12 that reside in Session Controller 42. Session Controller 42 triggers the start of Downlink Presence Timer 38 at reception of the first Notify message from Presence Server 28. Uplink Presence Timer 36 is started by Session Controller 42 at reception of the first MMI request for presence updates. Communication from UE 10 with Presence Server 28 is accomplished using SIP and the SIP specific event notification mechanism involving the SIP SUBSCRIBE request and SIP NOTIFY request.

To avoid extra traffic due to presence messages traveling back and forth over access network 16 as well as extra CPU processing between MMI Layer 44 and Lower Layer 46, Uplink Presence Timer 36 and Downlink Presence Timer 38 manage this message traffic. Both Uplink Presence Timer 36 and Downlink Presence Timer 38 are configurable parameters. Uplink Presence Timer 36 should always be greater than Downlink Presence Timer 38. Uplink Presence Timer 36 controls the flow of presence request messages from the UE 10 up to access network 16 and Downlink Presence Timer 38 controls the presence response messages coming back down from access network 16 to UE 10.

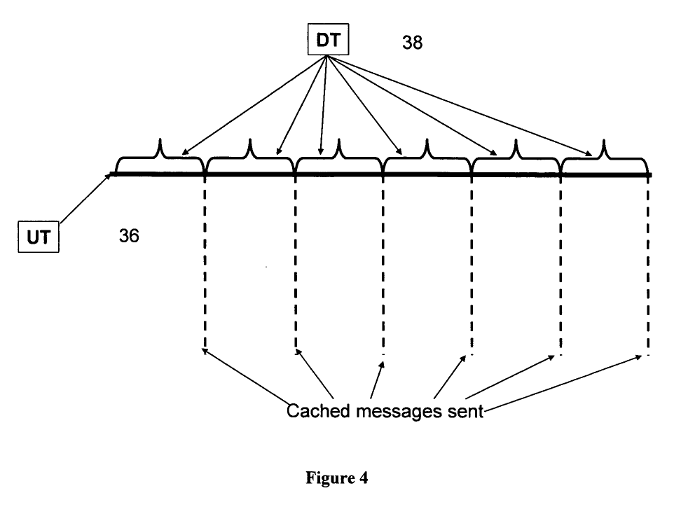

FIG. 4 shows the relationship between the two timers. Uplink Presence Timer 36 should be set so that multiple instances of Downlink Presence Timer 38 can occur within the Uplink Presence Timer 36 duration.

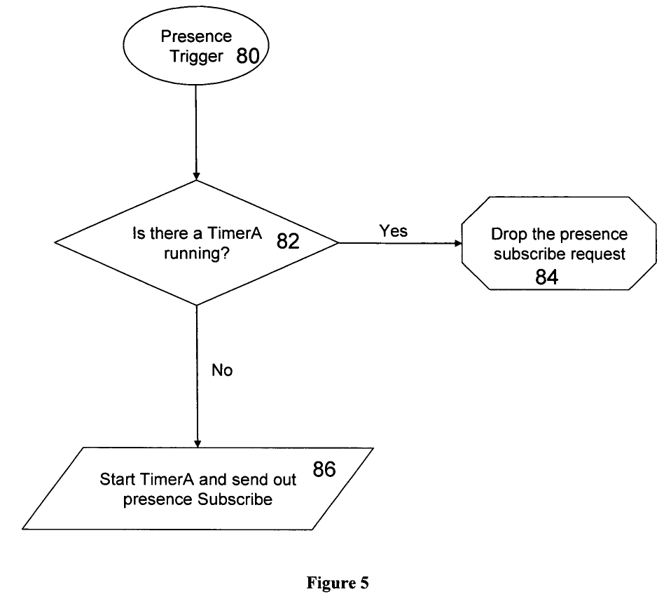

The process of Uplink Presence Timer 36 is shown in FIG. 5. When a user wants to update the presence status of his contacts in his Contact list, a request (presence trigger) is sent to PTT client (UE 10) (Step 80). Then Session Controller 42 determines if an Uplink Presence Timer 36 is running (Step 82). If there is an Uplink Presence Timer 36 running, the presence update request is dropped. Otherwise the presence update request is sent to access network 16 and an Uplink Presence Timer 36 is started (Step 86).

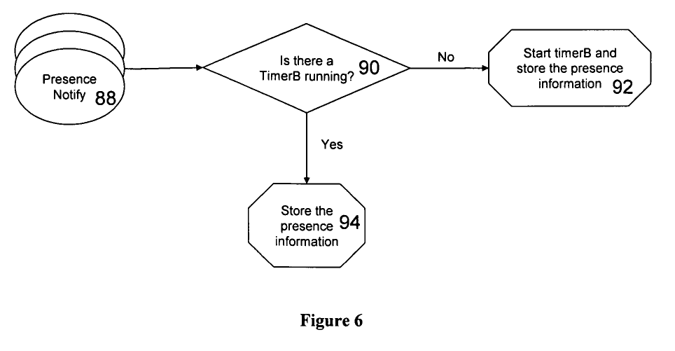

The process of Downlink Presence Timer 38 is shown in FIG. 6. When Presence Server 28 receives the presence request message, it generates responses in the form of Notify messages that contain the current presence status of the contacts (Step 88). Then Session Controller 42 determines if a Downlink Presence Timer 38 is already running or not (Step 90). When a Notify message comes down from Presence Server 28, and it is the first Notify message sent in response to the request message, then Downlink Presence Timer 38 is started and the first Notify message is cached (Step 92). While Downlink Presence Timer 38 is active all the Notify messages are cached for the duration of Downlink Presence Timer 38 (Step 94).

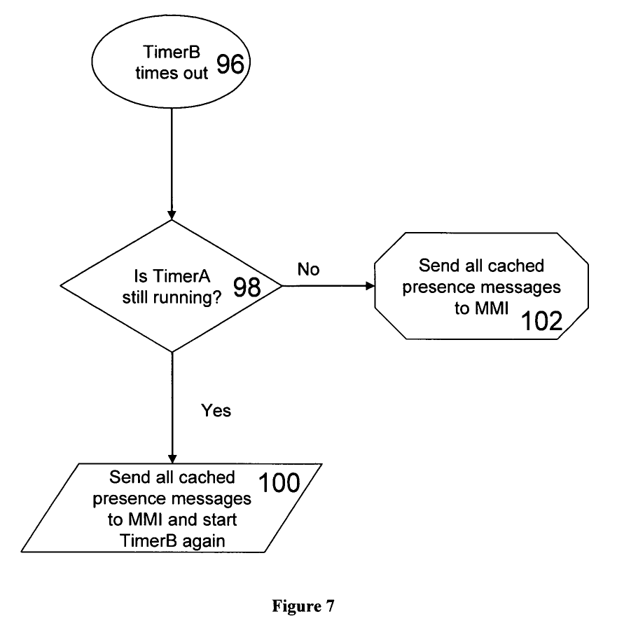

The continuous use of Presence Timer 34 is shown in FIG. 7. This process is initiated once Downlink Presence Timer 38 times out (Step 96). After Downlink Presence Timer 38 times out (step 96), Session Controller 42 determines if Uplink Presence Times 36 is still running (Step 98). If Uplink Presence Timer 36 is still running, Downlink Presence Timer 38 starts again and all cached NOTIFY messages are sent to MMI 40 (Step 100). As result of the restart of Downlink Presence Timer 38, future Notify messages are cached again for the duration of Downlink Presence Timer 38 (steps 88-94). This process continues repeating until Uplink Presence Timer 36 as determined in step 98. When the final Downlink Presence Timer 38 expires and Uplink Timer 36 expires, the remaining cached messages are sent to MMI (Step 102). When the sence request comes, the process is repeated (step 80).

### D. CONCLUSION

Having disclosed exemplary embodiments and the best mode, modifications and ns may be made to the disclosed embodiments while remaining within the subject and spirit vention as defined by the following claims.

I claim:

1. In a cellular network, a method for regulating packet traffic between a client device having a contact list, a first timer, a second timer and a man-machine interface (MMI) layer, and a server configured to update the contact list, comprising the steps of:
at the client device, generating a request to update the contact list;
determining if the first timer is running;
if the first timer is running, dropping the request; and
if the first timer is not running, starting the first timer and transmitting the request to the server.

2. The method recited in claim 1, further comprising the steps of:
at the client device in response to the transmitted update request, receiving an update containing presence information;
determining if the second timer is running;
if the second timer is running, caching the presence information; and
if the second timer is not running, starting the second timer and caching the presence information.

3. The method recited in claim 2, further comprising the steps of:
when the second timer times out, determining if the first timer is still running;
if the first timer is running, sending out the cached presence information to the MMI layer and restarting the second timer; and
if the first timer is not running, sending out the cached presence information to the MMI layer.

4. The method recited in claim 1, wherein the first timer is longer in duration than the second timer.

5. The method recited in claim 1, wherein the cellular network is a push-to-talk over cellular (PoC) network.

6. The method recited in claim 5, wherein the client device is a cellular handset.

7. The method recited in claim 5, wherein the request and update are based upon SIP.

8. The method recited in claim 7, wherein the request is a SUBSCRIBE message.

9. The method recited in claim 7, wherein the update is a NOTIFY message.

10. An improved push-to-talk enabled client device having a contact list and a man-machine interface (MMI) layer and configured to communicate over a push-to-talk network with a server to update the presence information in the contact list, the improvement comprising:
a first timer to control the transmission from the device to the server of a presence request to update the contact list; and
a second timer to control the receipt from the server to the device of a presence message with the presence update information.

11. The client device recited in claim 10, wherein when the presence request is generated, if the first timer is running, the presence request is dropped, and if the first timer is not running, the first timer is started and the presence request is transmitted to the server.

12. The client device recited in claim 11, wherein when the presence message is received by the device, if the second timer is running, the presence message is cached; and if the second timer is not running, the second timer is started and the presence message is cached.

13. The client device recited in claim 12, wherein when the second timer times out, if the first timer is running, the cached presence message is sent to the MMI layer and the second timer is restarted, and if the first timer is not running, the cached presence message is sent to the MMI layer.

14. The client device recited in claim 10, wherein the first timer is longer in duration than the second timer.

15. The client device recited in claim 10, wherein the push-to-talk network is a push-to-talk over cellular (PoC) network.

16. The client device recited in claim 15, wherein the client device is a cellular handset.

17. The client device recited in claim 15, wherein the presence request and the presence message are based upon SIP.

18. The client device recited in claim 17, wherein the presence request is a SUBSCRIBE message.

19. The client device recited in claim 17, wherein the presence message is a NOTIFY message.
